(19) United States
(12) Patent Application Publication
(10) Pub. No.: US 2003/0222923 A1
(43) Pub. Date: Dec. 4, 2003

(54) Menu user interface with size differentiation between enabled and disabled menu items

(75) Inventor: Jin Li, Toronto (CA)

Correspondence Address: Cynthia S. Byrd, International Business Machines, Intellectual Property Law, 11400 Burnet Road, Austin, TX, 78758, US

(73) Assignee: INTERNATIONAL BUSINESS MACHINES CORPORATION, Armonk, NY

(21) Appl. No.: 10/285,997

(22) Filed: Oct. 31, 2002

(30) Foreign Application Priority Data
May 29, 2002 (CA) 2,387,936

(51) Int. Cl. G09G 5/00

(52) U.S. Cl. 345/815; 345/821

(57) ABSTRACT

A menu user interface having menu items whose sizes are dependent upon their enabled or disabled status in disclosed. Enabled menu items are displayed in a standard size while disabled menu items are displayed in a reduced size. The reduced menu item size may be 50% of the standard size. Advantageously, the reduction in size of disabled menu items may in turn reduce the extent of the containing menu. Moreover, menu clutter may be reduced, and speed of access to individual menu items may be improved. The ordinal sequence of menu items may be invariable to facilitate a user's appreciation of the totality of available menu items and to facilitate location of a particular menu item.

### FIELD OF THE INVENTION

The present invention pertains to the field of software user interfaces, and more particularly to menu software user interfaces.

### BACKGROUND OF THE INVENTION

Software user interfaces, especially graphical user interfaces (GUIs), routinely utilize menus to present multiple options to a user. Many different types of menus are known.

Static menus are menus in which menu items are presented in an invariable ordinal sequence. An example of a static menu may be a “File” drop-down menu in a word processing application, which invariably provides three options “New”, “Open”, and “Close”, in that order, each time the menu is displayed. The ordinal position of the menu items remains fixed, even if one or more menu items is disabled (and thus “ghosted” or “grayed” for example). Users, especially novices, may benefit from the consistent layout in that location of a desired item and appreciation of the totality of available options are facilitated.

Disadvantageously, static menus may present two usability problems when the number of menu items is large. First, the menu may appear cluttered and may thus confuse the user. Second, the speed of access to a particular desired menu item may be diminished, e.g. if a long list must be scanned or if certain user interface mechanisms, such as scroll bars or an expandable menu hierarchy, are adopted to permit the menu to be displayed within the confines of a single screen.

Dynamic menus are context-sensitive menus in which the number of menu items and their arrangement may vary depending upon the state of the software. An example of a dynamic menu may be a pop-up menu in a word processing application, which presents different sets of menu items depending upon the type of word processing object that is selected. For example, the menu may display the menu items “Cut”, “Format Text”, and “Spell Check” when text is selected; alternatively, the menu may display the menu items “Cut”, “Rotate” and “Stretch” when a graphical object is selected. Advantageously, the use of such dynamic menus allows only those menu items that are relevant in view of the current software state to be displayed. This reduces menu clutter and may enhance speed of access of a particular option.

Disadvantageously, dynamic menus can present a number of usability problems, which may especially affect novice users. First, if the user fails to comprehend the preconditions for the display of a desired set of menu items (e.g. the need to select text versus a graphical object), the user may be unable to cause a desired menu item to appear and may thus be precluded from selecting a desired option. Second, because some menu items may not be displayed under certain conditions, the user may be precluded from appreciating the totality of available options. Third, the lack of predictable menu item ordinal positioning may confuse a user who is searching for a particular option.

Adaptive menus are menus in which only the frequently used or most recently used menu items are shown, typically in order of relative importance. An example of an adaptive menu may be the portion of a drop-down “File” menu in a word processing application in which the N most recently edited files appear as menu items displayed in order of most recent use. Like dynamic menus, adaptive menus may advantageously present the user with only the most relevant menu items and may thus reduce clutter and enhance speed of access. However, as with dynamic menus, adaptive menus may disadvantageously preclude the full set of menu items from being scanned by a novice user desirous of appreciating the totality of available options, and the lack of consistent menu item positioning may confuse a user searching for a particular option.

What is therefore needed is a menu, which addresses at least some of the above noted disadvantages.

### SUMMARY OF THE INVENTION

A menu user interface having menu items whose sizes are dependent upon their enabled or disabled status is disclosed. Enabled menu items are displayed in a standard size while disabled menu items are displayed in a reduced size. The reduced menu item size may be 50% of the standard size. Advantageously, the reduction in size of disabled menu items may in turn reduce the extent of the containing menu. Moreover, menu clutter may be reduced, and speed of access to individual menu items may be improved. The ordinal sequence of menu items may be invariable to facilitate a user's appreciation of the totality of available menu items and to facilitate location of a particular menu item.

In accordance with an aspect of the present invention there is provided a menu user interface including a plurality of menu items, each item being either in an enabled state or a disabled state, a given menu item, when in an enabled state, having a larger size than when in a disabled state.

In accordance with another aspect of the present invention there is provided a computer readable medium storing computer software that, when loaded into a computing device, adapts the device to display a menu user interface including a plurality of menu items, each item being either in an enabled state or a disabled state, a given menu item, when in an enabled state, having a larger size than when in a disabled state.

In accordance with still another aspect of the present invention there is provided a computing device including a processor and memory in communication with the processor, storing processor readable instructions adapting the device to display a menu user interface including a plurality of menu items, each item being either in an enabled state or a disabled state, a given menu item, when in an enabled state, having a larger size than when in a disabled state.

In accordance with yet another aspect of the present invention there is provided a method of displaying a menu, including: determining, from a context for the menu, a state for each menu item in the menu, the state being one of enabled and disabled; and based on a determined state of a given menu item, setting a display size for the menu item.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 illustrates a computing system capable of displaying menus in accordance with the present invention;

FIGS. 2A and 2B illustrate a graphical user interface (GUI) displayed by the computing system of FIG. 1 displaying a menu exemplary of the present invention;

FIGS. 3A and 3B illustrate menus displayed in conjunction with the GUI of FIGS. 2A and 2B (respectively) in greater detail;

FIG. 4 is a Unified Modeling Language (UML) schema illustrating a menu class and a menu item class used to implement the menus of FIGS. 3A and 3B;

FIGS. 5A and 5B illustrate a set of exemplary software objects at run time which correspond to the menus of FIGS. 3A and 3B respectively; and

FIG. 6 illustrates operation performed by the computing system of FIG. 1 to create the menus of FIGS. 3A and 3B.

### DETAILED DESCRIPTION

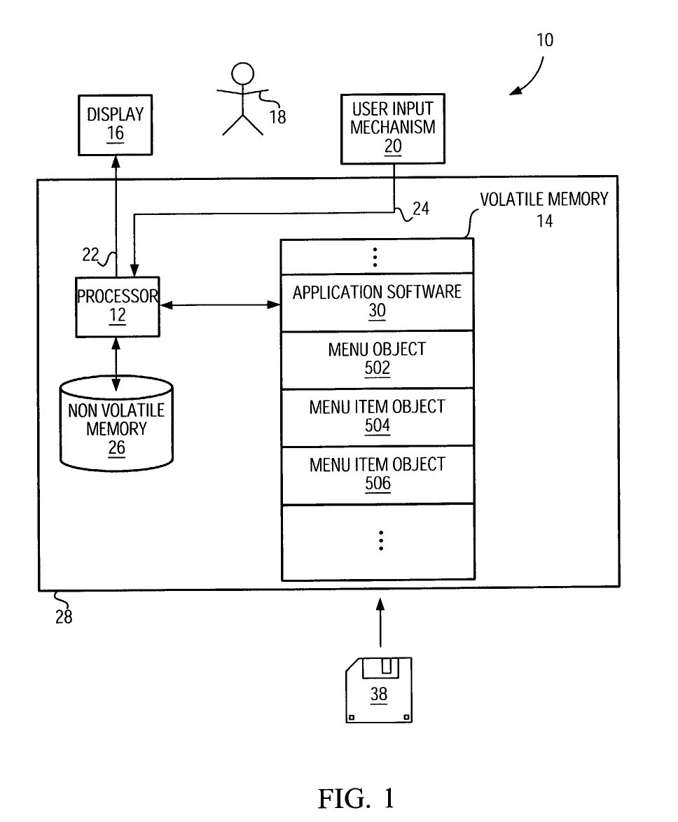

FIG. 1 illustrates an exemplary computing system 10 comprising a computing device 28 executing application software 30 stored in volatile memory 14 (e.g. RAM). The computing device 28, which may be a PC, server or handheld device for example, includes a processor 12 in communication with the volatile memory 14 as well as non-volatile memory 26 (e.g. a hard drive). The interconnections between the volatile and non-volatile memories 14 and 26 and the processor 12 are conventional. A display 16 for displaying a graphical user interface (GUI) to a user 18 and a user input mechanism (UIM) 20 for receiving input from the user 18 are interconnected with the processor 12 by way of links 22 and 24 respectively. The link 22 may not be a direct connection, and may for example include a video card (not shown) in communication with both the processor 12 (by way of a system bus) and a monitor in a conventional manner. The interconnection of the UIM 20 with the processor 12 is also conventional and may not be direct.

Display 16 is a conventional display device, such as a CRT, flat-screen monitor or liquid crystal display, capable of presenting a GUI to a user 18. The display 16 may form part of the computing device 28 comprising the computing system 10.

The user input mechanism 20 is a device or devices capable of generating user input representative of commands for operating the application software 40. The UIM 20 may be a keyboard, touch screen, or pointing device for example, or a combination of these devices. In the present embodiment the UIM 20 comprises a keyboard and a mouse capable of controlling a movable pointer on the display 16 for interacting with a GUI. The UIM 20 may form part of the computing device 28 which comprises the computing system 10.

The application software 30 is an application comprising executable code for displaying a GUI capable of displaying menus as described herein. In the present embodiment, the application is a word processing application. In alternative embodiments, however, the application may be any other type of application capable of displaying such menus.

The application software 30 may be developed using an object oriented language, such a C++ or Java™, and may incorporate code from a standard UI class library, such as the Microsoft® Foundation Class library, the Java™ Foundation Class Swing components from SUN® Microsystems (“Swing”), or the Standard Widget Toolkit from IBM® for example. The included UI class library may contain menu and menu item classes which may be instantiated to implement the GUI of the present embodiment. It should be appreciated, however, that it is not necessary for the programming language chosen to develop the application software 30 to be object oriented or for any standard UI class libraries to be employed. The application software 30 may be loaded into the volatile memory 14 of the system 10 from a computer readable medium, such as a removable optical or magnetic disk 38, or from resident non-volatile memory 26 such as a hard drive or a read only memory chip.

The volatile memory 14 of FIG. 1 contains a menu object 502 and two menu item objects 504 and 506. As will be described, these objects 502, 504 and 506 comprise instantiations of menu and menu item classes which implement a menu according to the present invention. It will be appreciated that the objects 502, 504 and 506 only exist in volatile memory 14 at run time.

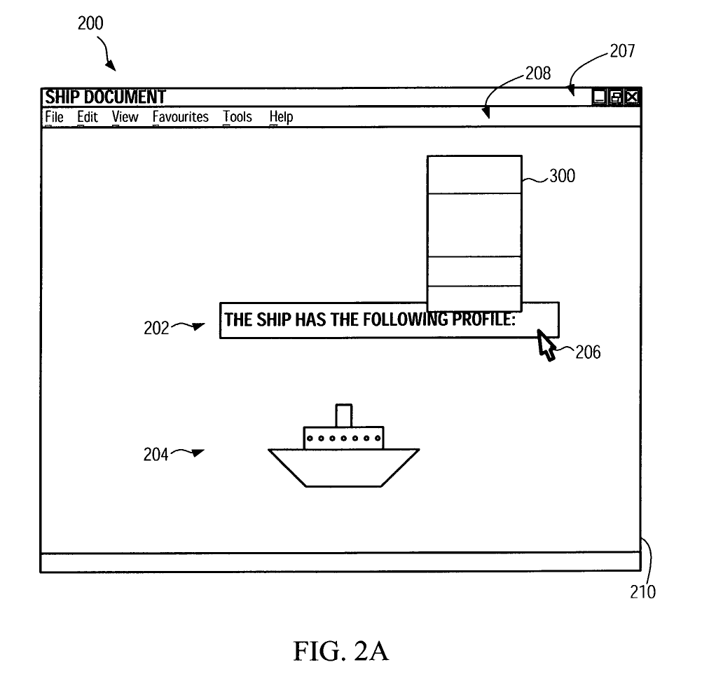

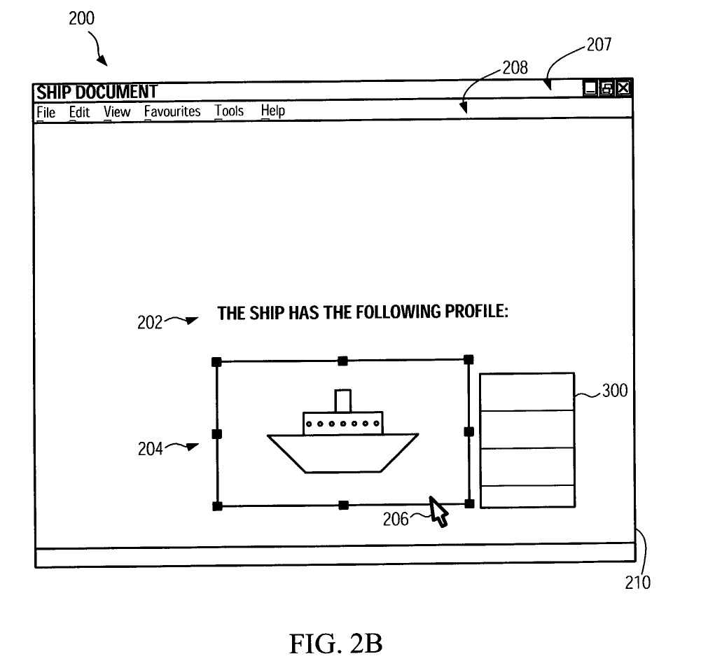

FIGS. 2A and 2B illustrate a GUI 200 generated by the word processing application software 30. The GUI 200 includes various elements commonly employed in word processing applications that are executable in a windowed operating system, including a title bar 207, menu bar 208, and document editing area 210. The GUI 200 further includes a menu 300 exemplary of an embodiment of the present invention, which is described in greater detail below.

The document editing area 210 of the GUI 200 shows a document that is currently loaded for editing. The document includes text 202 and a graphical object 204. These document components, as well as the elements of GUI 200 described above, are selectable by a movable pointer 206, in a conventional manner. FIG. 2A shows the state of the GUI 200 when the text 202 has been selected, while FIG. 2B shows the state of the GUI 200 when the graphical object 204 has been selected.

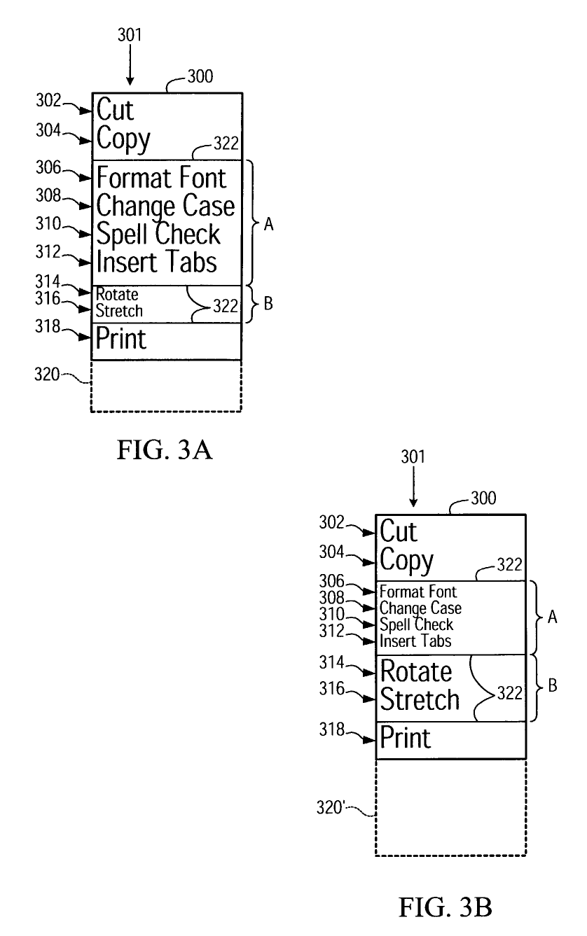

The popup menu 300 of FIGS. 2A and 2B is shown in greater detail in FIGS. 3A and 3B respectively. Accordingly, FIG. 3A illustrates the menu 300 as it appears when the text 202 is selected, and FIG. 3B illustrates the menu 300 as it appears when the graphical object 204 is selected.

Referring to FIG. 3A, the menu 300 includes nine menu items 301, each identifiable by its unique text. These include menu item 302 (“Cut”), 304 (“Copy”), 306 (“Format Font”), 308 (“Change Case”), 310 (“Spell Check”), 312 (“Insert Tabs”), 314 (“Rotate”), 316 (“Stretch”), and 318 (“Print”). Horizontal lines 322 separate the menu items 301 into groups, such as group A (representing operations that may be performed on text) and group B (representing operations that may be performed on a graphical object) for example.

As may be seen in FIG. 3A, two of the menu items 314, 316 are reduced in size by 50% in comparison to the standard size of the other seven menu items 302, 304, 306, 308, 310, 312, and 318. This reduced menu item size denotes the fact that menu items 314, 316 are presently disabled (the disablement being due to the fact that menu items 314 and 316 constitute operations on graphical objects which are inapplicable given that text 202, not being a graphical object, is selected). The remaining seven menu items that are displayed using a standard size font are enabled.

The diminished size of menu items 314 and 316 results in a diminished extent of the menu 300 as compared with a menu in which each menu item is displayed in a standard size. This diminished extent is represented by dotted outline 320 of FIG. 3A.

Turning now to FIG. 3B, the illustrated menu 300 includes has nine menu items 301, which are the same menu items 301 as appear in the menu 300 of FIG. 3A. The ordinal sequence of the menu items 301 of FIG. 3B is unchanged from FIG. 3A. However, the sizes of the menu items of FIG. 3B are different from the sizes shown in FIG. 3A. More specifically, menu items 306, 308, 310 and 312 are now at 50% of standard size while menu items 314 and 316 are now of standard size; the size of the remaining menu items 302, 304 and 318 is unchanged. It will be appreciated that this change in menu item sizes is due to the fact that the context for the menu 300 has changed, in that graphical object 204, as opposed to text 202, is now selected in FIG. 2B.

As in FIG. 3A, the menu 300 of FIG. 3B has a diminished extent due to the reduction in size of some of its menu items. However, because a greater number of menu items (menu items 306, 308, 310, and 312) have a reduced size in FIG. 3B than in FIG. 3A, the extent of menu 300 of FIG. 3B is even smaller than the extent of the menu 300 of FIG. 3A. This is reflected by the fact that the dotted outline 320′, which represents the amount by which the menu 300 of FIG. 3B is diminished from a comparable menu with standard size menu items, is larger than the dotted outline 320 of FIG. 3A.

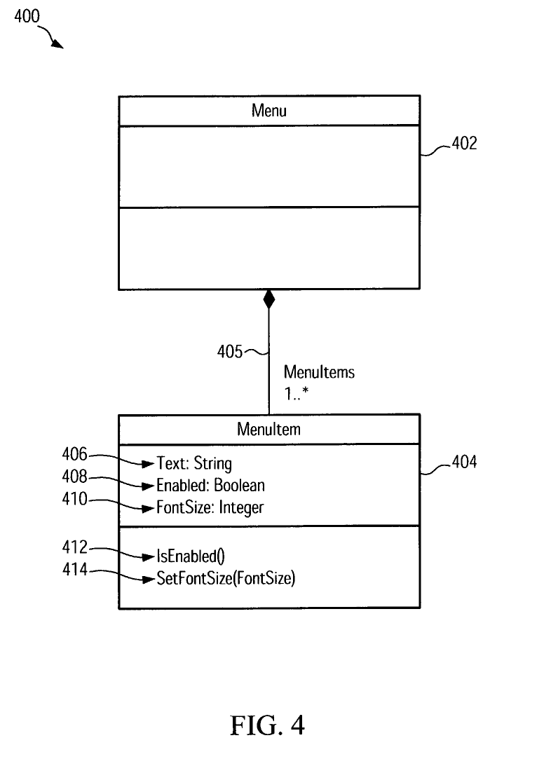

FIG. 4 illustrates a Unified Modeling Language (UML) schema 400 used to implement the menu 300 of FIGS. 3A and 3B. The schema 400 includes a Menu class 402 and a MenuItem class 404 in a composition relationship 405.

The Menu class 402 is associated with a menu object, such as menu 300, and includes various attributes and methods (not illustrated) for the purpose of maintaining or displaying the menu, as will be familiar to those skilled in the art.

The MenuItem class 404 is associated with a single menu item. Each menu item in a menu, such as each of the menu items 301 of FIG. 3A or 3B, is represented by a separate instance of the MenuItem class 404. The MenuItem class 404 has a string attribute “Text” 406 which comprises the text that is displayed in association with the menu item (e.g. “Cut” or “Copy”). The class 404 further has a boolean attribute “Enabled” 408. A value of TRUE for this attribute reflects an enabled status of the menu item, while a value of FALSE conversely reflects a disabled menu item status. The MenuItem class 404 further has an attribute “FontSize” 410 which represents the current font size (e.g. in points) of the menu item text 406. As will be appreciated, the value of the FontSize attribute 410 is tied to the value of the enabled attribute 408 in the present embodiment.

Further included in the MenuItem class 404 are two methods IsEnabled( ) 412 and SetFontSize( ) 414. The IsEnabled( ) method 412 returns the current enabled/disabled status of the associated menu item represented by the instance of class 404. The SetFontSize( ) method receives a single input parameter representative of the desired font size of the text 406 and sets the font size accordingly.

Additional attributes and methods may be included in Menu class 402 and MenuItem class 404 despite not being illustrated.

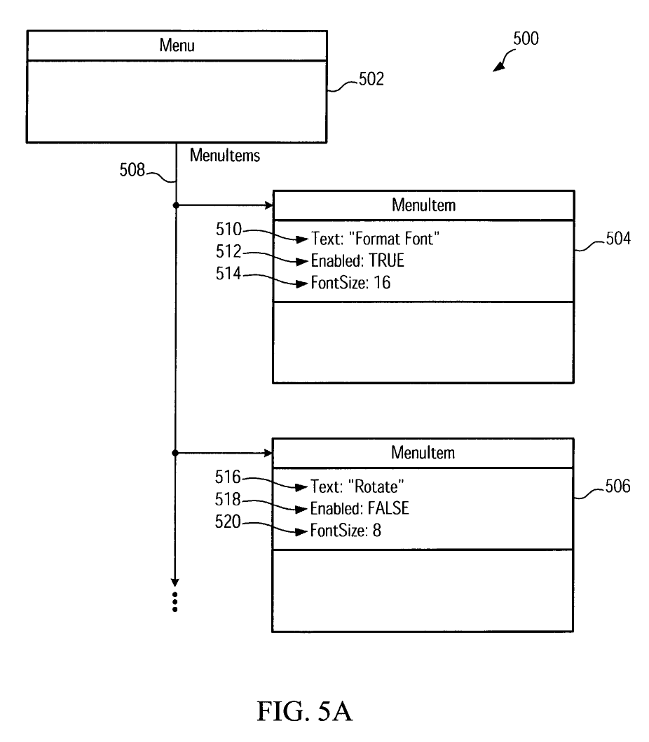

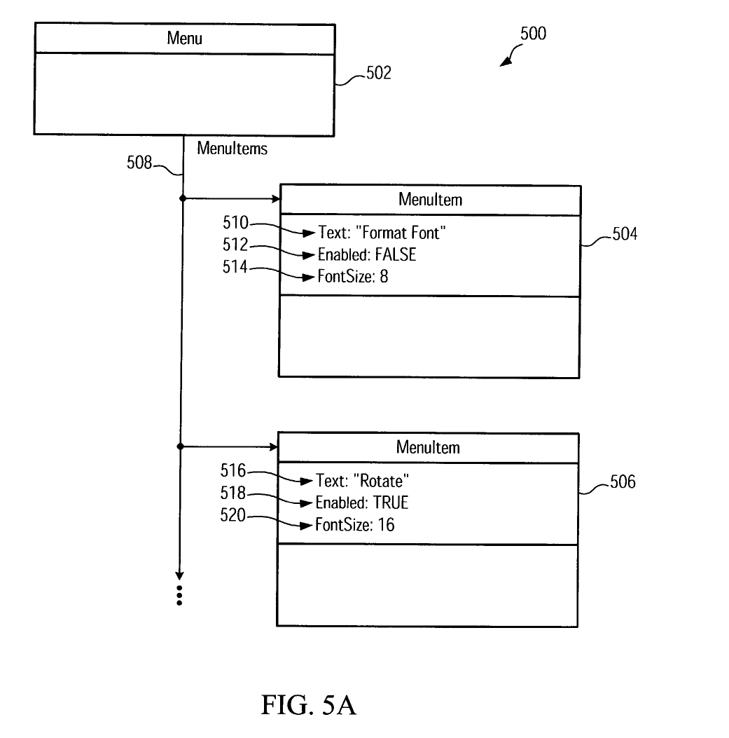

FIGS. 5A and 5B illustrate an exemplary set of software objects 500 that is created in volatile memory 14 in conjunction with the display of menu 300. It will be appreciated that the set of objects 500 in FIGS. 5A and 5B represent the menu 300 of FIGS. 3A and 3B respectively.

Referring to FIG. 5A, the set of objects 500 includes a menu object 502 and two menu item objects 504 and 506 contained by menu object 502 by way of composition relationship 508. These three objects are the same objects shown in volatile memory 14 in FIG. 1. It will be appreciated that the menu object 502 is an instantiation of the Menu class 402; the menu item objects 504 and 506 are each an instantiation of MenuItem class 404; and the composition relationship 508 is an instantiation of composition relationship 405 (FIG. 4). The two menu item objects 504 and 506 of FIG. 5A represent only two of the total of nine menu item objects that are contained by the menu object 502 (one for each of the nine menu items 301); the other seven are omitted for clarity. The first menu item object 504 illustrates an enabled menu item (“Format Font” menu item 306) and the second menu item object 506 illustrates a disabled menu item (“Rotate” menu item 314).

Turning to FIG. 5B, the same set of objects 500 are illustrated, except the enabled and disabled state of the menu item objects 504 and 506 is reversed. These two objects correspond to the state of menu items 306 and 314 of FIG. 3B.

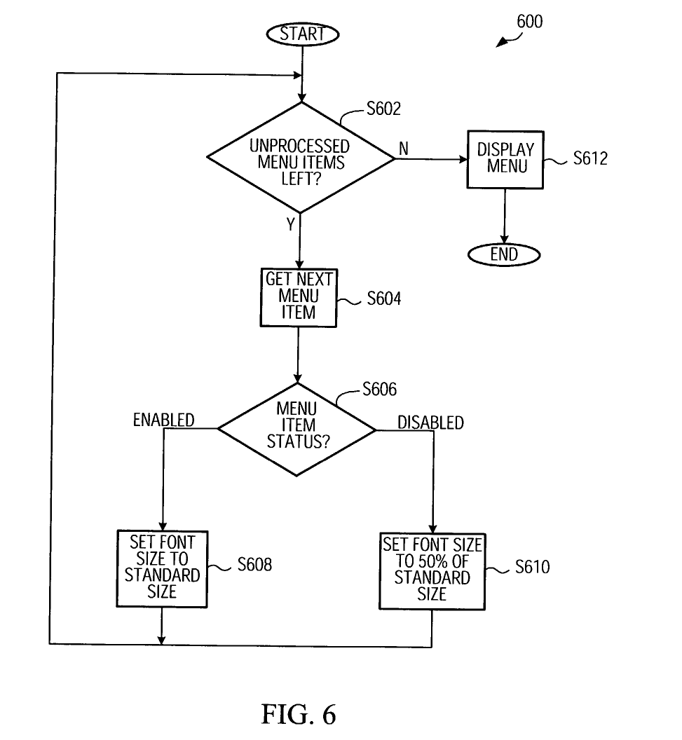

The operation of the present embodiment is illustrated in the flowchart of steps 600 of FIG. 6, with additional reference to FIGS. 1, 2A, 2B, 3A, 3B, 4, 5A and 5B. It is initially assumed that the word processing application software 30 has been invoked to edit the document shown in FIGS. 2A and 2B and that a user 18 of the computing system 10 (FIG. 1) has used the mouse of UIM 20 to select text 202 with the movable pointer 206 as shown in FIG. 2A. It is further assumed that some event has occurred (e.g. a right-click of the mouse by the user 18) that will cause the menu 300 of FIG. 3A to be displayed. It is additionally assumed that, prior to the execution of the steps 600 of FIG. 6, the enabled/disabled status of each of the menu items 301 has been determined by business logic within the application software 30 on the basis of the current context for the menu 300 (e.g. whether text or a graphical object has been selected), and that the “enabled” attribute 408 of each of the nine menu item objects in the set of objects 500 (FIG. 5A) has been accordingly set.

Accordingly, the loop of steps S602, S604, S606, S608 and S610 is executed for each of the nine menu items of FIG. 3A. During each pass through the loop, the IsEnabled( ) method 412 of the current menu item object is invoked (step S606) to determine whether the current menu item should be displayed in an enabled or disabled state. If it is determined in step S606 that the menu item is enabled, the font size of the corresponding menu item text is set to a standard size (16 points) in step S608. Otherwise, the font size of the menu item text is set to a size that is 50% of the standard size (8 points) in step S610. The result of the execution of these steps is shown in the exemplary menu item objects 504 and 506 of FIG. 5A, in which the FontSize attributes 514 are set to a point size of 16 and 8 in view of the values TRUE and FALSE (respectively) of their enabled attributes 512.

After the font size of each of the nine menu items 301 has been set in steps S602 to S610, the menu is displayed in step S612 in a conventional manner. The displayed menu appears as shown in FIG. 3A. Advantageously, the reduction in size of disabled menu items results in a menu 300 with an extent that is reduced by the area 320 as compared with a corresponding menu in which each menu item is of a standard size. Moreover, the reduction in size of disabled menu items of the menu 300 reduces menu clutter and may improve speed of access of a particular menu item. The operation of steps 600 is thus completed.

Next, it is assumed that the sequence of steps 600 is performed after the user 18 has selected the graphical object 204 as shown in FIG. 2B rather than after selecting text 202 as shown in FIG. 2A. This results in the set of objects 500 of FIG. 5B and in the display of a menu 300 as it appears in FIG. 3B. It will be appreciated that although the enabled/disabled status of the nine menu items 301 is different from FIG. 3A, the menu items of FIG. 3B are in the same ordinal sequence as in FIG. 3A. Advantageously, this consistent ordering of menu items may assist the user 18 in locating a particular menu item; moreover, the display of all menu items (even disabled ones) allows the user 18 to better appreciate the totality of available menu items.

As will be appreciated by those skilled in the art, modifications to the above-described embodiment can be made without departing from the essence of the invention. For example, although the present embodiment illustrates menu item sizes being reduced by way of a reduction in the font size of menu item text, it is possible for the size of menu items to be reduced using other techniques. For example, in a system where each menu item of a menu is allocated some predetermined amount of display “real estate” regardless of the font size of its text, this amount of allocated real estate may be reduced for disabled menu items rather than the font size of the menu item text. In this case, each menu item will have the same size font regardless of its enabled/disabled status, but the size of the area allocated to each menu item may differ depending on whether it is enabled or disabled.

As well, it is not necessary for the reduction in size of a disabled menu item to be exactly 50%. Rather, any appreciable reduction in size for a disabled menu item may be implemented, provided that the identity of the reduced size menu items remains comprehensible to a user.

Further, while the menu 300 of the present embodiment is illustrated as having an invariable ordinal sequence of its menu items 301, it will be appreciated that the reduction in size of disabled menu items may be implemented for menus in which the ordinal menu item sequence is variable (e.g. in the manner of a traditional dynamic menu). Of course, menus, which have a variable menu item ordering, may not provide all of the advantages associated with an invariable ordinal sequence, noted above.

Further, while the present embodiment illustrates a floating or popup menu, it will be appreciated that alternative embodiments may be menus of other types, such as pull down menus.

Also, it will further be appreciated that the present invention is equally applicable to static, adaptive and dynamic menus.

Finally, those skilled in the art will recognize that alternative object oriented embodiments of the application software may employ menu-related classes whose attributes, methods and names differ from those of the described embodiment.

Other modifications will be apparent to those skilled in the art and, therefore, the invention is defined in the claims.

The embodiments of the invention in which an exclusive property or privilege is claimed are defined as follows:

1. A menu user interface comprising a plurality of menu items, each item being either in an enabled state or a disabled state, a given menu item, when in an enabled state, having a larger size than when in a disabled state.

2. The menu user interface of claim 1 wherein said size is a font size.

3. The menu user interface of claim 1 wherein said size of said given menu item when in said disabled state is about 50% of said size of said given menu item when in said enabled state.

4. The menu user interface of claim 1 wherein said plurality of menu items has an ordinal sequence that is invariable irrespective of the state of each of said plurality of menu items.

5. A computer readable medium storing computer software that, when loaded into a computing device, adapts said device to display a menu user interface including a plurality of menu items, each item being either in an enabled state or a disabled state, a given menu item, when in an enabled state, having a larger size than when in a disabled state.

6. The computer readable medium of claim 5 wherein said size is a font size.

7. The computer readable medium of claim 5 wherein said size of said given menu item when in said disabled state is about 50% of said size of said given menu item when in said enabled state.

8. The computer readable medium of claim 5 wherein said plurality of menu items has an ordinal sequence that is invariable irrespective of the state of each of said plurality of menu items

9. A computing device comprising a processor and memory in communication with said processor, storing processor readable instructions adapting said device to display a menu user interface including a plurality of menu items, each item being either in an enabled state or a disabled state, a given menu item, when in an enabled state, having a larger size than when in a disabled state.

10. The computing device of claim 9 wherein said size is a font size.

11. The computing device of claim 9 wherein said size of said given menu item when in said disabled state is about 50% of said size of said given menu item when in said enabled state.

12. The computing device of claim 9 wherein said plurality of menu items has an ordinal sequence that is invariable irrespective of the state of each of said plurality of menu items.

13. A method of displaying a menu, comprising:
determining, from a context for said menu, a state for each menu item in said menu, said state being one of enabled and disabled; and
based on a determined state of a given menu item, setting a display size for said menu item.

14. The method of claim 13 wherein said display size is a reduced display size when said given menu item is in said disabled state.
